(19) United States
(12) Patent Application Publication
(10) Pub. No.: US 2007/0169643 A1
(43) Pub. Date: Jul. 26, 2007

(54) Clear stamp and method of manufacturing same

(76) Inventors: M. Ann Merrill, Draper, UT (US); Joyce Leung, Shanghai (CN); Eddy Chik, Shanghai (CN)

Correspondence Address: MORRISS OBRYANT COMPAGNI, P.C., 734 EAST 200 SOUTH, SALT LAKE CITY, UT, 84102, US

(21) Appl. No.: 11/486,556

(22) Filed: Jul. 14, 2006

Related U.S. Application Data
(60) Provisional application No. 60/699,089, filed on Jul. 14, 2005.

(51) Int. Cl. B41J 1/60

(52) U.S. Cl. 101/109

(57) ABSTRACT

Embodiments of the present invention include ink stamp dies, ink stamps and methods of manufacturing the same. Embodiments of the ink stamp dies may include two different materials. The first material may be opaque and the second material may be substantially transparent and adhered to the first material. The second material may be configured to be softer than the first for better adhesion properties to its base and/or to better deform to uneven surfaces when applying the stamp to a particular substrate.

### CROSS-REFERENCE TO RELATED APPLICATION

This application claims the benefit of U.S. Provisional Application No. 60/699,089, filed Jul. 14, 2005, which is incorporated herein by reference in its entirety.

### BACKGROUND

1. Field of the Invention

This invention relates generally to rubber ink stamps, and more specifically relates to a transparent rubber stamp.

2. Description of Related Art

Many types of stamping devices have been developed over the years for stamping inked lettering, logos and decorative images on paper and other surfaces for various applications. Some example applications for stamping devices include postmarking mail, marking documents for status such as “confidential” or “draft,” the application of decorative designs on paper in scrapbooks and any other conceivable situation where the rapid application of words, logos or designs on the surface of an object is desired.

Conventional stamping devices may be made with a plastic or wooden handle having an elastomeric material with the desired pattern formed thereon which may be secured to a bottom surface of the handle. By applying ink to the image surface, a user may then use the handle to apply the inked image to paper or any other suitable surface.

Conventional stamps typically employ compressible foam padding in-between the handle and the elastomeric die to provide even application of the die surface when the stamp is applied at angles off of perpendicular and for uneven surfaces for which the image or design is being applied. Where the elastomeric material is permanently affixed to the bottom of the stamp handle, with or without a foam padding, many stamps are necessarily one for each image to be applied.

Additionally, where the handle of a stamp is formed of opaque materials, such as wood, the handle of the stamp itself obstructs the user's view of the image that is being stamped and the location for the desired image application. Thus, it is often times difficult to align the stamp image with the desired location on the target surface for application.

To overcome the need for a large number of separate stamps and the need for the person using the ink stamp to be able to see through a handle or a die mounting device for better alignment and placement of the image, various stamping devices have been developed with handles having detachable elastomeric dies or embossed members so that a transparent handle may be used with more than one die or embossed member. Examples of such devices are disclosed in U.S. Pat. Nos. 6,827,014 to Marshall et al., U.S. Pat. No. 6,422,140 to Lookholder et al., U.S. Pat. No. 6,324,977 to Hadden, U.S. Pat. No. 5,642,667 to Sastre, U.S. Pat. No. 5,313,885 to Winston and U.S. Pat. No. 3,973,495 to Rowe. Each of these patents discloses the use of a substantially transparent handle to facilitate the alignment of the die against the location for application of the desired image on the target object. One disadvantage of such transparent stamps is that because the entire die is formed from a transparent or translucent material, it is often difficult if not impossible to actually see the image provided on the stamping portion of the stamping die.

Also, a disadvantage with ink stamps having removable printing dies is that the use of an intermediate padding material and/or forming the elastomeric printing die from an opaque material obscures the outline and details of the printing die image during application regardless of the transparent handle. U.S. Pat. No. 6,422,140 to Lookholder et al. addresses this disadvantage by eliminating the use of a foam padding material and providing a substantially transparent printing die in combination with a substantially transparent handle to more precisely align the die image prior to application.

However, a remaining disadvantage of the Lookholder et al. stamp is that by removing the foam padding, the stamp becomes more susceptible to uneven application on less than flat surfaces or by application of the stamp at angles other than 90° relative to the target surface.

Thus, there exists a need in the art for a clear ink stamp and method of manufacturing same that provides a substantially transparent ink die formed of at least two elastomeric materials having different properties for use with a substantially clear handle. There also exists a need in the art for an ink stamp die that compensates for application of the stamp to uneven surfaces or at angles other than 90° relative to the target surface. There further exists a need in the art for an ink stamp die that provides easy visualization of the image provided by the stamp, even when viewing the image from the back side of the stamp through the base portion of the stamp.

### SUMMARY

Illustrative embodiments of methods of manufacturing substantially transparent ink stamp dies are disclosed according to the present invention. The methods may include providing a mold configured for receiving molding material and having indentations on an inside bottom surface corresponding to a preselected design. The methods may further include providing a first molding material comprising an opaque elastomeric material configured for disposing on the inside bottom surface of the mold and capable of being cured to a resilient and elastically deformable shape. The methods may further include providing a second molding material comprising a substantially transparent elastomeric material configured for disposing on the inside bottom surface of the mold and configured for adhering to the first molding material. In some embodiments, the second molding material is capable of being cured to a resilient and elastically deformable shape softer than the first molding material. The methods may further include placing the first molding material in the mold to fill the indentations on the inside bottom surface of the mold, the first molding material being opaque in nature and of a dark color (e.g., black). The methods may further include placing the second molding material on top of the first molding material in the mold. The methods may further include curing the molding materials. The methods may further include separating the cured molding materials from the mold.

Embodiments of ink stamp dies are also disclosed according to the present invention. An ink stamp die may include a first elastomeric material configured in a preselected design for receiving ink. The first elastomeric material may be opaque and of a dark color (e.g., black). The ink stamp dies may further include a second substantially transparent elastomeric material integrally formed or otherwise bonded to, the first elastomeric material. The second elastomeric material may be configured to be softer than the first for better adhesion properties to its base and/or to better deform to uneven surfaces when applying ink on the stamp to a particular substrate.

Embodiments of ink stamps are disclosed according to the present invention. An ink stamp may include a handle and an ink stamp die wherein the ink stamp die is configured for removable adhesion to the handle. The ink stamp die may further include a first elastomeric material configured in a preselected design for receiving ink and a second substantially transparent elastomeric material, configured to be softer than, and integrally formed with or otherwise bonded to, the first elastomeric material.

Additional features and advantages of the invention will be apparent from the detailed description which follows, taken in conjunction with the accompanying drawings, which together illustrate, by way of example, features of embodiments of the present invention.

### DESCRIPTION OF THE DRAWINGS

The following drawings illustrate exemplary embodiments for carrying out the invention. Like reference numerals refer to like parts in different views or embodiments of the present invention in the drawings.

FIG. 1 is a flow chart of an embodiment of a method of manufacturing a substantially transparent ink stamp die according to the present invention.

FIG. 2 is a top view of an exemplary embodiment of an ink stamp die in a mold according to the present invention.

FIG. 3 is a cross section view of the embodiment of the ink stamp die shown in FIG. 2.

FIG. 4 is a bottom view of another embodiment of an ink stamp die according to the present invention.

FIG. 5 is an elevated top view of the embodiment of another ink stamp die according to the present invention.

FIG. 6 is a bottom view of an embodiment of an ink stamp according to the present invention including the ink stamp die shown in FIG. 4.

FIG. 7 is an elevated top view of the embodiment of an ink stamp according to the present invention including the ink stamp die shown in FIG. 5.

FIG. 8 is a cross-sectional side view of the ink stamp shown in FIG. 7.

### DETAILED DESCRIPTION

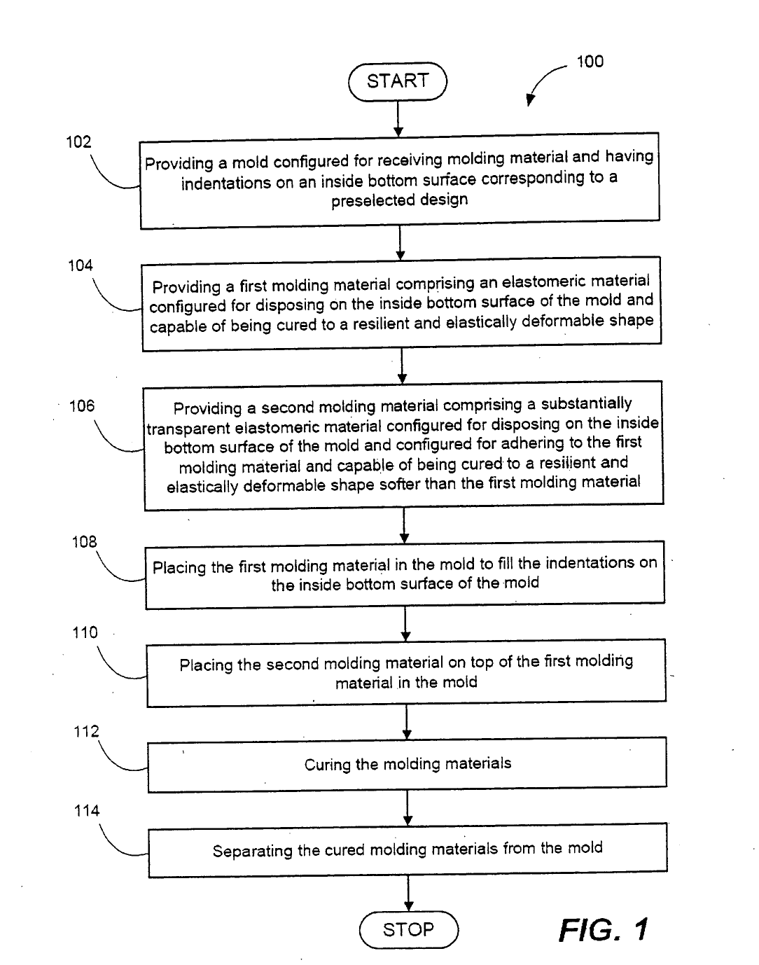

FIG. 1 is a flow chart of one illustrative embodiment of a method 100 of manufacturing a substantially transparent ink stamp die according to the present invention. Method 100 may include providing 102 a mold configured for receiving molding material and having indentations on an inside bottom surface corresponding to a preselected design. The mold may have any arbitrary design formed into the indentations on the inside bottom surface of the mold. The mold may be formed from any suitable material, such as steel, other metals, glass, plastics or other materials, according to any suitable method or acquired from a supplier of same. Molds suitable for forming ink stamp dies are known to those of ordinary skill in the art and, thus, will not be further elaborated on herein.

Method 100 may further include providing 104 a first molding material comprising an elastomeric material configured for disposing on the inside bottom surface of the mold and capable of being cured to a resilient and elastically deformable shape. The first molding material may be comprised of any suitable molding material, such as various forms of rubber, silicon rubber, plastics or polyvinyl chloride-based materials, and configured to form the ink receiving portion of the ink stamp die when disposed into the mold by pouring or injection or any other suitable means known to those skilled in the art. For example and not by way of limitation, the first molding material may be formed of a photopolymer such as a liquid polyester that will polymerize when exposed to ultraviolet light according to an embodiment of method 100. According to another embodiment of method 100 the first molding material may be an opaque elastomeric material. An advantage of using an opaque elastomeric material for forming the first molding material used to form the preselected design for the ink stamp die is that it will be visible if viewed through a substantially transparent second molding material and a transparent handle. This allows the user to see the image to be stamped by a stamping die of the present invention through the back side of the stamp for proper placement on a given medium, such as paper or other materials known in the art of stamping.

Method 100 may further include providing 106 a second molding material comprising a substantially transparent elastomeric material configured for disposing on the inside bottom surface of the mold and configured for adhering to the first molding material and capable of being cured to a resilient and elastically deformable shape softer than the first molding material. Photopolymers are readily commercially available from several sources such as The Louis Melind Company, Inc. of Skokie, Ill., U.S.A. The first and the second molding materials may comprise photopolymers according to embodiments of the present invention. The first and the second molding materials may comprise polyvinyl chloride (PVC) according to other embodiments of the present invention.

According to other embodiments of method 100, the second molding material may comprise any suitable polymer that exhibits viscoelastic characteristics that enables a surface formed thereof to be removably affixed to a surface of a handle without the use of an adhesive. Such viscoelastic polymers in effect exhibit a multiplicity of very small suction-cup like protuberances which releasably grip the smooth surfaces of the handle, such as a block of clear acrylic, to which it may be attached. The use of a viscoelastic polymer has the advantage of entirely eliminating the need for an adhesive. Furthermore, by using a viscoelastic polymer, removal of the ink stamp die may be achieved by simply peeling the ink stamp die away from the surface of the handle.

Method 100 may further include placing 108 the first molding material in the mold to at least partially fill the indentations on the inside bottom surface of the mold and placing 110 the second molding material on top of the first molding material in the mold. The first and second molding materials may be disposed into the mold by pouring or injection or any other suitable means known to those skilled in the art. The second molding material is configured to adhere, as by chemical bonding, to the first molding material such that when cured, the two molding materials form a unitary ink stamp die.

Method 100 may further include curing the molding materials. Where liquid photopolymers are used for molding materials, curing may be achieved by applying ultraviolet light to polymerize the photopolymers. Other molding materials may be cured by heat (thermal curing) or any other suitable means of curing the molding material.

A particularly important feature of the method 100 according to the present invention is that once cured, the first molding material is harder and less elastically deformable than the second molding material. This allows the first molding material to push into the second molding material when stamping. The softer second molding material, thus, gives relative to the first molding material behaving much like foam padding used in conventional ink stamps, thus, allowing a better application of the image or design formed on the ink stamp die when used on uneven surfaces or at angles other than perpendicular to the surface of the target object receiving the ink stamp. According to an embodiment of method 100, the first and second molding materials may be formed of PVC. In such an embodiment, the second molding material may be made softer than the first molding material by using the addition of petroleum prior to curing. In addition, by pouring a first molding material into the mold, the first molding material can have any other desired properties that are different from the second molding material so long as the first and second molding materials bond when cured. Thus, in a particular embodiment of the present invention, the first molding material is opaque and dark in color, while the second molding material is substantially transparent. Thus, the two molding materials may be identical in chemical composition with the first molding material having a coloring agent applied thereto to darken the molding material. The first molding material thus forms the portion of the stamp that creates the image (i.e., the projected surfaces that transfer ink to a desired surface. As such, when viewing the stamp image through the back of the stamp (i.e., through the second molding material), the image of the stamp is clearly visible.

Method 100 may further include separating the cured molding materials from the mold to obtain the unitary ink stamp die for use with a handle for a stamp. Method 100 may be used to manufacture a virtually limitless variety of ink stamp dies consistent with embodiments of the present invention.

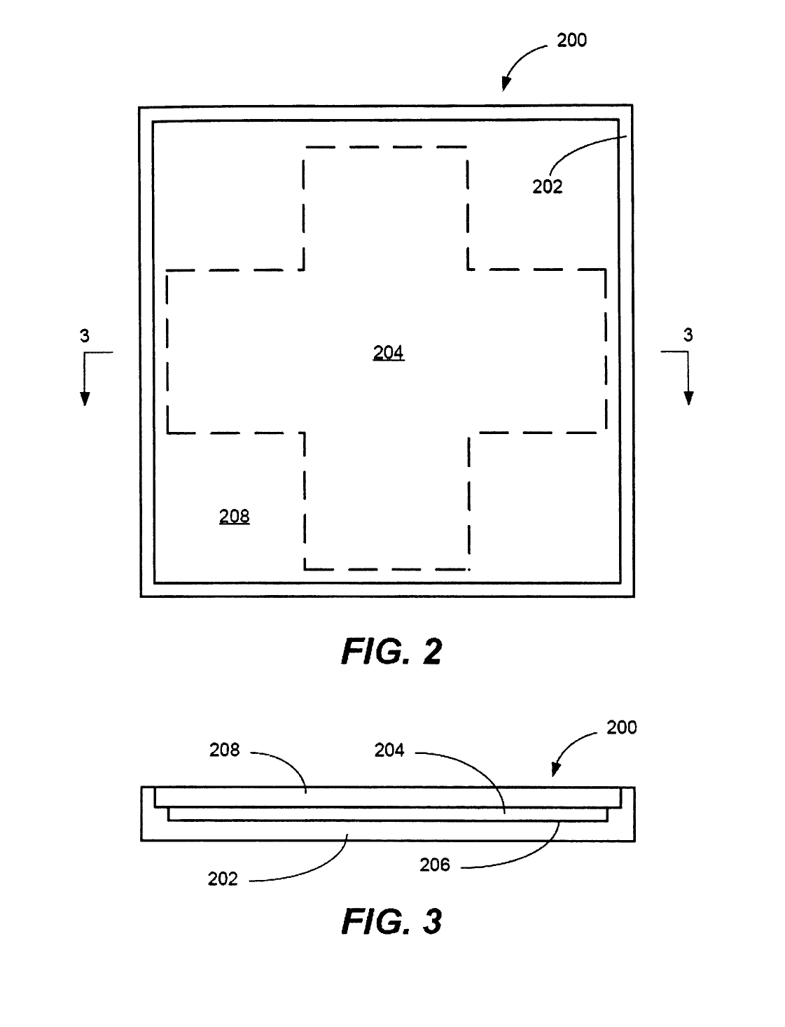

Referring now to FIGS. 2 and 3, an exemplary embodiment of an ink stamp 200 in a mold 202 is shown. FIG. 2 is a top view of the embodiment of an ink stamp die 200 in a mold 206 according to the present invention. FIG. 3 is a cross-section view of the embodiment of the ink stamp die 200 shown and indicated in FIG. 2. The dimensions of the features shown in FIGS. 2 and 3 are not shown to scale and are shown enlarged for ease of viewing. The ink stamp die 200 includes a first elastomeric material 204 that may be configured in a preselected design (e.g., a “plus sign” in dotted line as shown FIG. 2) that is configured from the shape of the indentations 206 in the mold 202. The ink stamp die 200 further includes a second elastomeric material 208 on top of and adhered to the first elastomeric material 204. The composition of the first and second elastomeric materials 204, 208 may be as disclosed elsewhere herein. The composition and formation of the mold 202 may be any suitable mold material manufactured according to methods known to those of ordinary skill in the art.

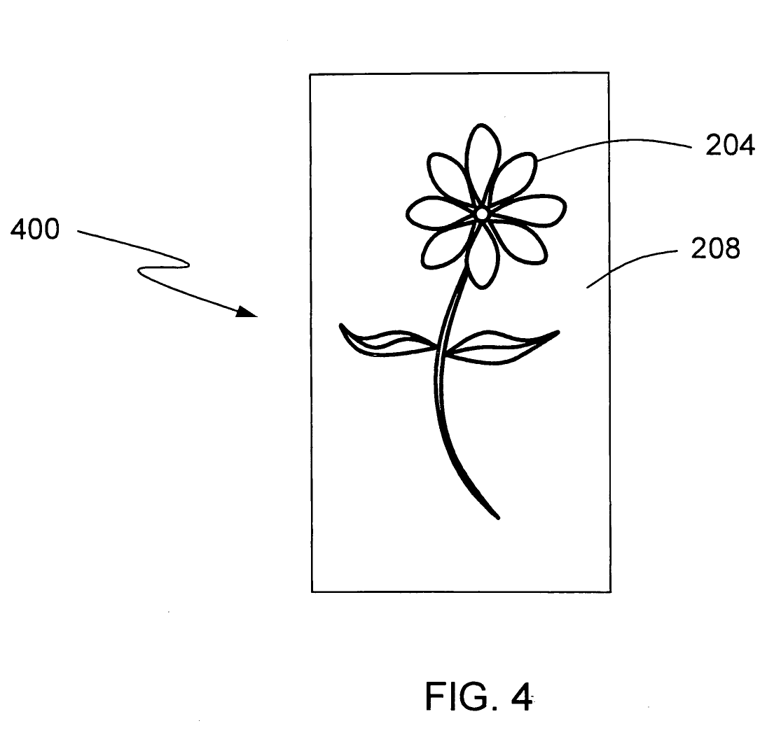

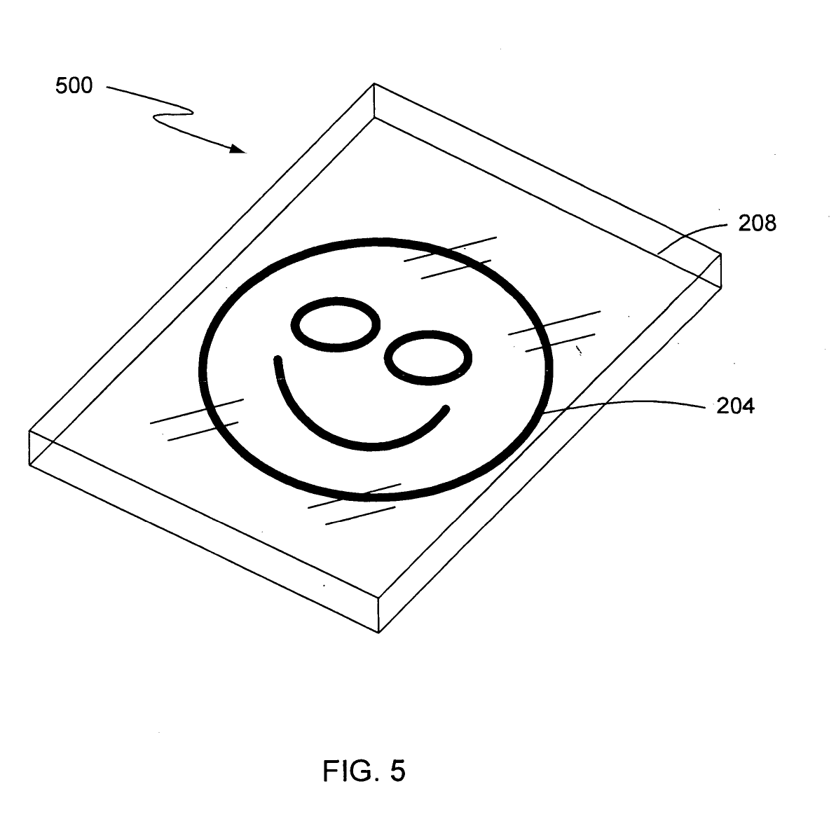

FIG. 4 is a bottom view of another embodiment of an ink stamp die 400 according to the present invention. Ink stamp die 400 may include a first elastomeric material 204 configured in a preselected design (e.g., a “flower design” as shown in FIG. 4) for receiving ink and a second substantially transparent elastomeric material 208, configured to be softer than, and adhered to, the first elastomeric material 204. The preselected design may be virtually any image (e.g., a “flower design” as shown in FIG. 4) that the user desires to apply in ink to an object, see also the exemplary “plus sign” design shown in FIG. 2.

FIG. 5 is an elevated top view of the embodiment of an ink stamp die 500, with like elements using the same reference numerals as in FIG. 4. The second substantially transparent elastomeric material 208 may be formed of any suitable rubber or polymer molding material, for example and not by way of limitation a photopolymer according to an embodiments of the present invention. Because the second substantially transparent elastomeric material 208 is transparent and the first substantially transparent elastomeric material 204 is opaque and darkened in color, the underlying first elastomeric material and its pattern (e.g., a “smiley face design”) are visible through the second substantially transparent elastomeric material 208.

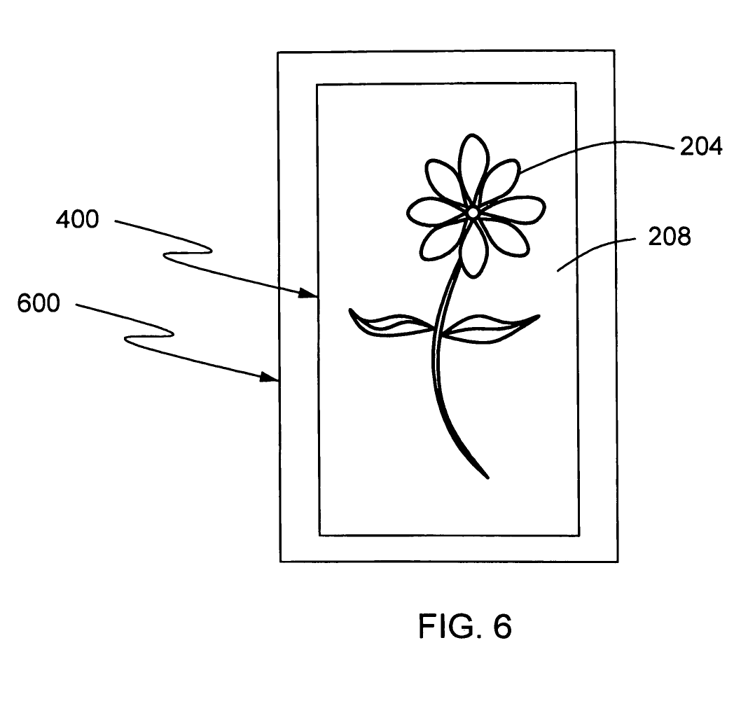

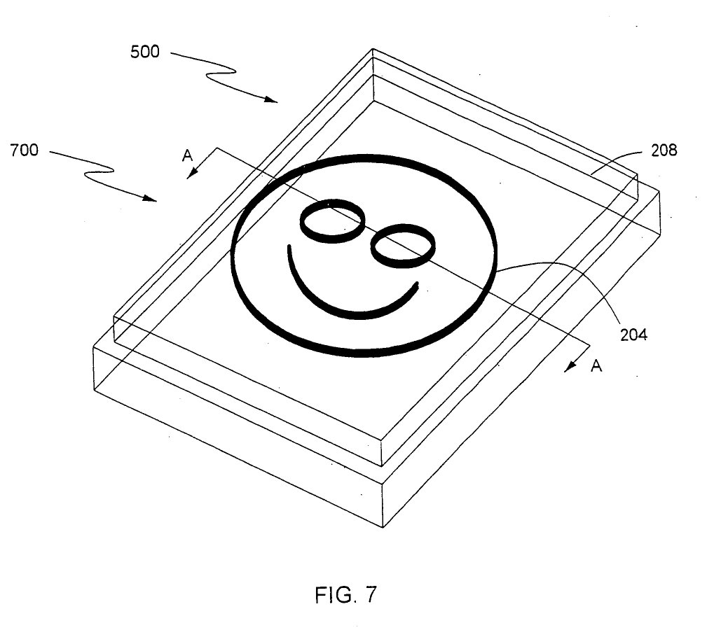

In yet another embodiment of the ink stamp die 200, 400, or 500, the second substantially transparent elastomeric material 208 may be formed of a viscoelastic polymer. The viscoelastic polymer allows the ink stamp die 200 to adhere to the smooth surface of a handle (see handle 602 in FIGS. 6 and 7). The combination of the second substantially transparent elastomeric material 208 formed of a viscoelastic polymer adhered to a clear plastic acrylic handle, for example, allows the user to see through the handle and the second substantially transparent elastomeric material.

Referring again to FIG. 5 and according to still another embodiment of an ink stamp die, the first elastomeric material 204 may be formed of an opaque material. For example and not by way of limitation, the first elastomeric material 204 may be formed of an opaque black material as shown in FIG. 5. By using an opaque material for the first elastomeric material 204 in combination with the second substantially transparent elastomeric material, the preselected design (e.g., a letter as shown in FIG. 5) will be visible to the user of the ink stamp die 500 when viewed through the second substantially transparent elastomeric material 208 (see FIGS. 3-5). This allows the user to accurately align the preselected design of the ink stamp die 500 prior to application of ink on the target object (not shown in FIGS.). According to another embodiment of the ink stamp die 200, 400, or 500, the first elastomeric material 204 may be formed of a photopolymer. The use of photopolymers facilitates curing of the elastomeric molding compounds through use of ultraviolet light.

Another feature of embodiments of an ink stamp die 200, 400, or 500, according to the present invention relates to the relative hardness of the two elastomeric material layers 204, 208. Specifically, where the preselected design formed of the first elastomeric material 204 is harder than the second substantially transparent elastomeric material 208, the preselected design maintains its shape when forced against the second substantially transparent elastomeric material 208. This feature allows ink stamps (e.g., see 600 in FIG. 6 and related discussion below) using the inventive ink stamp dies 200, 400 to be used on uneven target surfaces (not shown in the FIGS.) or at angles slightly off of perpendicular relative to the target surface. In addition, the use of a firmer image elastomeric layer 204 prevents ink form contacting the softer base layer 208 that would otherwise limit the ability to see through the back side of the stamp 400. Thus, according to an embodiment of an ink stamp die 200, 400, the second substantially transparent elastomeric material 208 may be configured to be elastically deformable relative to the first elastomeric material 204. Embodiments of ink stamp die 200, 400 may be formed from PVC, wherein the second substantially transparent elastomeric material 208 may be softer than the first elastomeric material 204, by the addition of petroleum to material 208 prior to curing.

FIG. 6 is a bottom view of an embodiment of an ink stamp 600 according to the present invention including the ink stamp die 400 shown in FIG. 4. Ink stamp 600 may include a handle 602 and an ink stamp die 400, wherein the ink stamp die 400 is configured for removable adhesion to the handle 602. The ink stamp die 400 may be any embodiment of an ink stamp die according to the present invention or disclosed herein, including, e.g., the embodiment of an ink stamp die 200 shown in FIGS. 2 and 3. An embodiment of a handle 602 may be formed of a block of clear acrylic or other transparent materials (such as glass or polycarbonate) to which the stamp die 400 can be attached, whether by self-adhesion due to the adhesive properties of the second layer to the handle 602 or by a transparent adhesive applied between the stamp die 400 and the handle 602, like the handle 602 shown in FIGS. 6-7.

Desirable features of the handle 602 include transparency and a smooth surface for removably adhering the ink stamp die 400. According to another embodiment of an ink stamp 600, the second substantially transparent elastomeric material (see 208 in FIGS. 2-5) of the ink stamp die 400 may be configured for removable adhesion to the handle 602 without an adhesive. According to yet another embodiment of an ink stamp 600, the second substantially transparent elastomeric material (see 208 in FIGS. 2-5) of the ink stamp die 400 may be formed of a viscoelastic polymer.

FIG. 7 is an elevated top view of the embodiment of an ink stamp 700 including the ink stamp die 500 shown in FIG. 5. Note that the ink stamp die 500 is visible through the handle 602. According to a further embodiment of ink stamp 700 the object for receiving an inked image of the preselected design of the ink stamp 700 may be visible through the handle 602 and through the second substantially transparent elastomeric material (208 in FIGS. 2-5).

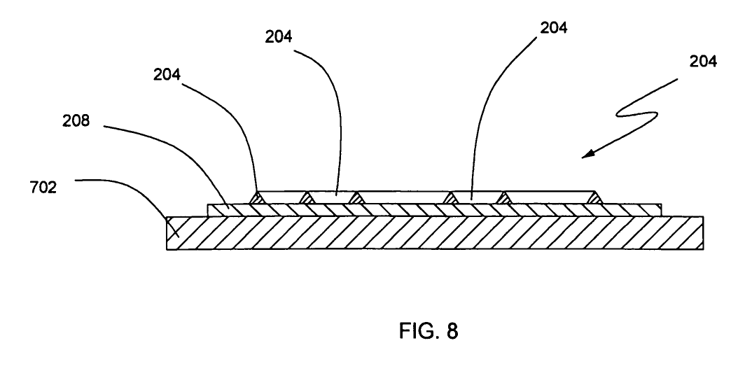

As further illustrated in FIG. 8, which represents cross-section A-A of FIG. 7, the ink stamp 700 is comprised of three basic components. The handle 702 which is formed from a rigid transparent material, such as a transparent acrylic, glass, polycarbonate or other suitable material, forms a base for supporting the flexible stamp components 204 and 208. The stamp base 208 is formed from a flexible and resilient material that also exhibits viscoelastic properties to temporarily adhere itself to the handle 702. Bonded to the stamp base 208 is a plurality of raised portions 204 formed from an opaque stamping material that is flexible and resilient. The plurality of raised portions are formed into a desired pattern that is used to carry the ink and which will define the image to be transferred from the stamp to a desired medium, such as a sheet of paper.

While the foregoing advantages of the present invention are manifested in the illustrated embodiments of the invention, a variety of changes can be made to the configuration, design and construction of the invention to achieve those advantages. Hence, reference herein to specific details of the structure and function of the embodiments of the present invention are by way of example only and not by way of limitation.

What is claimed is:

1. A method of manufacturing a substantially transparent ink stamp die, comprising:
disposing a first molding material comprising an elastomeric material capable of being cured to a resilient and elastically deformable shape on an inside bottom surface of a mold having indentations on an inside bottom surface corresponding to a preselected design to fill the indentations on the inside bottom surface of the mold;
disposing a second molding material comprising a substantially transparent elastomeric material capable of being cured to a resilient and elastically deformable shape softer than the first molding material on top of the first molding material in the mold; and
curing the first and second molding materials.

2. The method of manufacturing an ink stamp die according to claim 1, further comprising separating the cured molding materials from the mold.

3. The method of manufacturing an ink stamp die according to claim 1, wherein disposing a second molding material comprises disposing a viscoelastic polymer.

4. The method of manufacturing an ink stamp die according to claim 1, wherein disposing the first molding material comprises disposing at least one of a photopolymer or polyvinyl chloride (PVC).

5. The method of manufacturing an ink stamp die according to claim 1, wherein disposing the second molding material comprises disposing at least one of a photopolymer or polyvinyl chloride (PVC).

6. The method of manufacturing an ink stamp die according to claim 1, wherein disposing the first molding material comprises providing an opaque elastomeric material.

7. An ink stamp die, comprising:
a first elastomeric material configured in a preselected design for receiving ink; and
a second substantially transparent elastomeric material, configured to be softer than, and adhere to, the first elastomeric material.

8. The ink stamp die according to claim 7, wherein the first elastomeric material comprises an opaque material.

9. The ink stamp die according to claim 7, wherein the first elastomeric material comprises a photopolymer.

10. The ink stamp die according to claim 7, wherein the second elastomeric material comprises a viscoelastic polymer.

11. The ink stamp die according to claim 7, wherein the preselected design formed in the first elastomeric material is configured to maintain its shape when forced against the second substantially transparent elastomeric material.

12. The ink stamp die according to claim 7, wherein the second substantially transparent elastomeric material is configured to be elastically deformable relative to the first elastomeric material.

13. An ink stamp, comprising:
a handle;
an ink stamp die, comprising:
a first elastomeric opaque material configured in a preselected design for receiving ink; and
a second substantially transparent elastomeric material integrally formed with the first elastomeric material.

14. The ink stamp of claim 13, wherein said second substantially transparent elastomeric material is softer than said first elastomeric opaque material.

15. The ink stamp of claim 13, wherein the ink stamp die is configured for removable adhesion to the handle.

16. The ink stamp according to claim 13, wherein the handle comprises a block of clear acrylic.

17. The ink stamp according to claim 13, wherein the second substantially transparent elastomeric material of the ink stamp die is configured for removable adhesion to the handle without an adhesive.

18. The ink stamp according to claim 13, wherein the second substantially transparent elastomeric material comprises a viscoelastic polymer.

19. The ink stamp according to claim 13, wherein the ink stamp die is visible through the handle.

20. The ink stamp according to claim 13, wherein an object for receiving an inked image of the preselected design of the ink stamp is visible through the handle and through the second substantially transparent elastomeric material.
